(19) United States
(12) Patent Application Publication
(10) Pub. No.: US 2002/0052791 A1
(43) Pub. Date: May 2, 2002

(54) REMOTE TRANSACTION TRACKING AND FINANCIAL PACKAGE LINK

(76) Inventors: James M. Defede, Boise, ID (US); Roger C. Henderson, Boise, ID (US)

Correspondence Address: CRAIG M KORFANTA, P O BOX 1840, BOISE, ID, 837011840

(21) Appl. No.: 09/420,599

(22) Filed: Oct. 19, 1999

Related U.S. Application Data
(60) Provisional application No. 60/104,891, filed on Oct. 19, 1998.

(51) Int. Cl. G06F 17/60

(52) U.S. Cl. 705/16

(57) ABSTRACT

A software program which provides the user with a familiar simple user interface, such as a Windows® environment, to import remote transaction tracking data from a remote location into a financial software data format in a central computer. Herein, the phrase “financial software data format” means a format which forms part of the existing data structure of the financial software, e.g. native data file structure, or a format which is directly supported and importable into the financial software. Most financial software programs use unique data structures which render the data unusable by other software. In the context of the native data file structure as an “financial software data format” file, the imported data has been merged directly into the data file used by the financial software. A large number of software packages support import and export of data interchange file formats such as delimited ASCII or similar files. Unfortunately, the order and identification of the individual data within the file is not standard. The invention formats the data into a format which the importing client expects.

### RELATED APPLICATIONS

This application claims the priority under 35 USC §119(e) of provisional application Serial No. 60/104,891 filed on Oct. 18, 1998, which is herein incorporated by reference in its entirety.

Microfiche Appendix: This specification has appended hereto a microfiche appendix having X fiche containing Y frames.

### BACKGROUND OF THE INVENTION

1. Technical Field

This invention generally relates to financial software and systems. More particularly, this invention relates to software for a computer which gathers data from remote transaction tracking system, such as point of sale systems, and imports this data either directly into a financial software package, such as an accounting package, or into a file format capable of being read by a financial package.

2. Background

Many retail sale environments use point of sales (POS) systems for recording sales transactions, order entry, inventory tracking, employee time entry, daily receipt tracking, etc., instead of traditional cash registers. The data generated by these systems is quite useful for business management purposes. Normally, data is collected from many different POS terminals onto a central computer and stored in a format unique to the software managing the POS system. Unfortunately, this data has to be manually transferred from the POS system to the accounting software used for business management. This normally involves printing various data reports from the POS system, sending these reports to the central office and having the data read from the reports and manually keyed in to the accounting software at the central office.

Multiple location retail stores require that each location maintain a separate subset of accounting records, all of which then must be merged into a complete data set for the entire retail company. This requires a complicated chart of accounts and meticulous location data tracking, all custom tailored to the particular company and the software and hardware combination the company chooses to implement. Additionally, each POS manufacturer and financial software provider has its own data structure and file format which are largely incompatible. It is very difficult for one supplier to produce a single integrated system which satisfies all users needs. There are several different POS systems available as well as a multitude of financial software programs.

To date, this combination of problems has prohibited anyone from providing an automatic data import system which transfers POS data directly into the financial software data files or into a file format which can be directly imported into the financial software. While some transaction tracking systems are capable of generating interchange files in a raw data format that is technically compatible with the financial software, e.g. the financial software is capable of reading comma delimited ASCII text, the data structure of the interchange files are not compatible with what the financial software expects.

### SUMMARY OF THE INVENTION

According to the present invention, this general end is achieved by a software program which provides the user with a familiar simple user interface, such as a Windows® environment, to import POS data from a remote location into a financial software data format in a central computer. Herein, the phrase “financial software data format” means a format which forms part of the existing data structure of the financial software, e.g. native data file structure, or a format and file structure which is directly supported and importable into the financial software. Most financial software programs use unique data structures which render the data unusable by other software. In the context of the native data file structure as an “financial software data format” file, the imported data has been merged directly into the data file used by the financial software. A large number of software packages support import and export of data interchange file formats such as delimited ASCII or similar files. Unfortunately, the order and identification of the individual data within the file is not standard. This means that the user must map the data manually when transferring from one file structure to another. Hence, herein in the context of a data interchange file format as an “financial software data format” file, the data in the file has been arranged to match the data arrangement expected by the particular financial software and appears in a format readable by the software.

The invention accomplishes this by maintaining and using extensive import and export file format libraries containing file structure information and data validation rules, by incorporating and applying extensive accounting intelligence and by maintaining and using extensive file location information. The file location information is gathered from the user as a result of queries requesting the location and file types of the files that contain specific types of financial data needed by the financial package. The data gathering is modular in the sense that several different files may contain the data needed by the financial software, hence the invention allows data to be gathered from different files. The data is both imported and exported intelligently in the sense that only the data that is needed is imported and the data is exported into the financial software data format for the particular financial software and in the sense that transactions which violate accepted accounting rules are prohibited and/or brought to the attention of the user.

Additional advantages and novel features of the invention will be set forth in part in the description that follows, in the attached appendix and in part will become apparent to those skilled in the art upon examination of the following or may be learned by practice of the invention. The advantages of the invention may be realized and attained by means of the instrumentalities and combinations particularly pointed out in the appended claims.

### BRIEF DESCRIPTION OF THE DRAWINGS

FIG. 1 is a schematic representation of a retail environment in which the invention may be implemented;

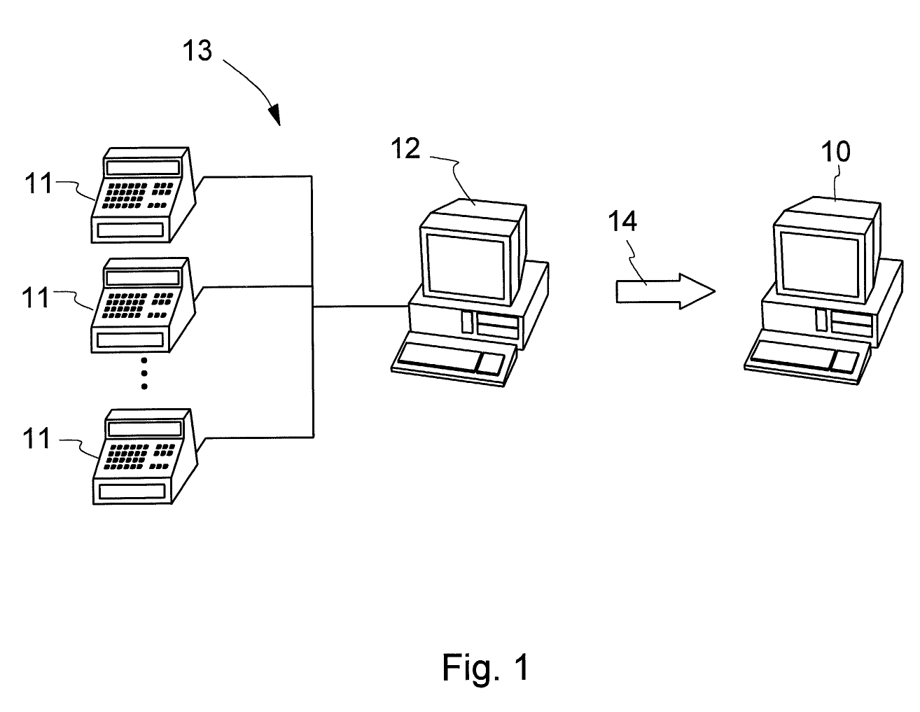

FIG. 2 is a block diagram representation of software according to one embodiment of the invention;

FIG. 3 is a high-level flow diagram of software according to one embodiment of the invention, showing the first two hierarchies of the flow chart;

FIG. 4a is a flow diagram of software according to the embodiment of FIG. 3, showing the cash import, over/short, deposit and detail sales entry procedures as lower level hierarchies of the flow chart;

FIG. 4b is a flow diagram of software according to the embodiment of FIG. 3, showing the detail sales, detail voucher, and detail inventory entry procedures as lower level hierarchies of the flow chart;

FIG. 4c is a flow diagram of software according to the embodiment of FIG. 3, showing the employee, daily time, weekly time and period time entry procedures as lower level hierarchies of the flow chart;

FIG. 5a is a screen printout of a financial location import setup screen according to one embodiment of the invention;

FIG. 5b is a screen printout of a financial location transfer setup screen according to one embodiment of the invention;

FIG. 5c is a screen printout of a financial location definition setup screen according to one embodiment of the invention;

FIG. 5d is a screen printout of a financial location calculations setup screen according to one embodiment of the invention;

FIG. 6 is a screen printout of a payroll location setup screen according to one embodiment of the invention;

FIG. 7 is a screen printout of a payroll department, payroll job title, payroll pay code and employee matching setup screens according to one embodiment of the invention;

FIG. 8 is a screen printout of a mass location update screen according to one embodiment of the invention;

FIG. 9a is a screen printout of a daily summary screen according to one embodiment of the invention;

FIG. 9b is a screen printout of a daily summary sales summary screen according to one embodiment of the invention;

FIG. 9c is a screen printout of a daily summary detail screen according to one embodiment of the invention;

FIG. 9d is a screen printout of a multiple location financial import and transfer screen according to one embodiment of the invention;

FIG. 10 is a screen printout of an employee import maintenance screen according to one embodiment of the invention;

FIG. 11 is a screen printout of a timecard import maintenance screen according to one embodiment of the invention;

FIG. 12a is a screen printout of a timecard payroll import and transfer screen according to one embodiment of the invention;

FIG. 12b is a screen printout of an employees payroll import and transfer screen according to one embodiment of the invention;

FIG. 12c is a screen printout of a maintenance payroll import and transfer screen according to one embodiment of the invention;

FIG. 13a is a screen printout of a payables location setup screen according to one embodiment of the invention;

FIG. 13b is a screen printout of a single voucher entry screen according to one embodiment of the invention; and

FIG. 13c is a screen printout of a mass voucher import screen according to one embodiment of the invention.

### DETAILED DESCRIPTION OF THE INVENTION

Referring now to the figures, a link between a remote transaction tracking system, also generally referred to herein as data collection system, and financial software is illustrated. Reference is made to a POS system as a particular data collection system and to an accounting software package as a particular financial package. This particular embodiment the invention includes a software component generally designated as 100, a computer 10 which executes the software, a data collection point, a communications link between the data collection point and computer 10 and one or more data collectors. Computer 10 is here a general purpose personal computer having: a non-volatile storage media, such as a disk drive or similar memory, for storing software and data; a processor for executing the instructions contained within software; and random access memory (RAM) for storing instructions, data and results during execution.

The data collectors 11 may be devices such as point of sale devices or intelligent cash registers, while the data collection point may be a remotely centralized computer 12 linked to one or more data collectors 11. A typical system might include several POS devices 11 each linked to a data collection point 12, e.g. remotely centralized computer 12, via a wiring network, a computer network, the Internet, a telecommunications network or some other local or remote communications link. POS devices 11 and data collection point 12 are typically located at a single location such as a retail outlet or restaurant, generally designated at 13. In some systems, data collection point 12 and a single POS device 11 may be incorporated into the same device.

Data collection point 12 is linkable to computer 10 via a communications link 14, such as a modem, a telecommunications network, a computer network, the Internet, an email interface, an FTP interface, an infrared link, or the like to establish at least a read-only link, which allows computer 10 to read data from data collection point 12. Preferably a bi-directional communications link is used, which not only allows computer 10 to read data from data collection point 12 but also to write data to data collection point 12 to correct erroneous data, provide additional data and possibly even reconfigure data collection point 12 and/or POS devices 11. As is explained later, different embodiments of software 100 can act as either a one-way data conduit or a two-way data conduit between the data collection system and a financial software package by intelligently translating data between the two systems.

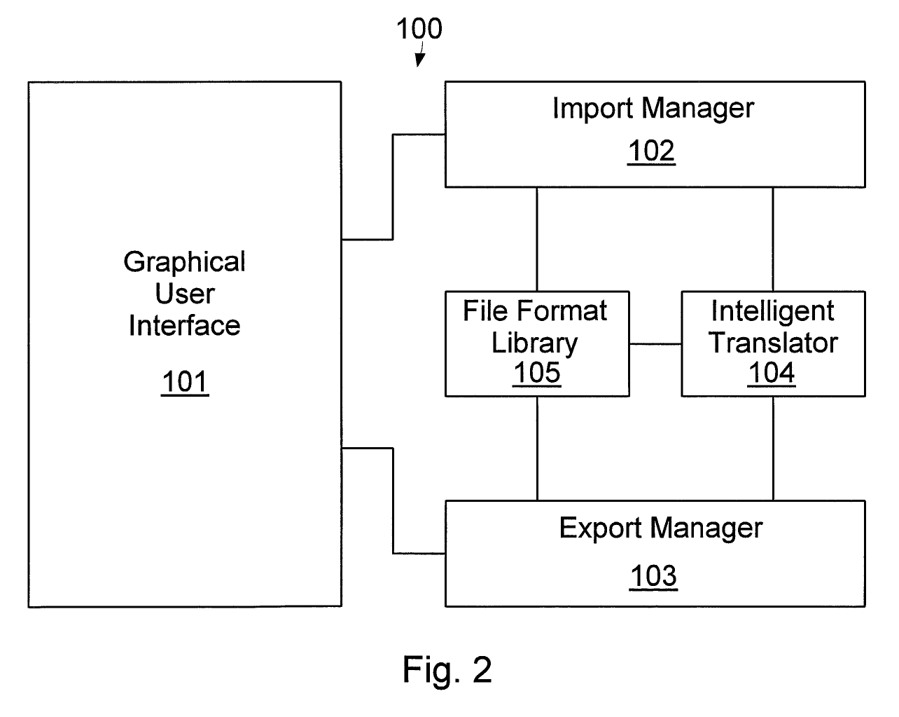

The block diagram schematic of FIG. 2 illustrates the five main conceptual building blocks according to one software embodiment 100. Software 100 includes a graphical user interface (GUI) 101, an import manager 102, an export manager 103, an intelligent translator 104 and a file format library 105. GUI 101 provides the user interface which allows the user to interact with the software. Upon setup, GUI 101 gathers data location information as well as general information from the user concerning the location of the data collection system, type of data collection system or systems in use, the names or identification of the systems, model number of the system, version number of the system, which data is to be imported. Data gathering is modular in the sense that several different files may contain the data needed by the financial software, hence the invention allows data to be gathered from different files. GUI 101 also allows the user to customize account names, numbers and definitions, as well as how the data is transferred and what, if any, calculations are performed during the transfer.

Import manager 102, export manager 103, intelligent translator 104 and file format library 105 all work in conjunction to grab data from data collection point 12 and translate the data into financial software data format. File format library 105 contains extensive information regarding both the mapping of data locations within data collection point and financial software data files as well as the data structure and accounting characteristics of the data. Generally, the information within file format library 105 is pre-loaded by the manufacturer. However, another embodiment of the invention provides a mapping utility which allows the user to define both data collection system and financial software data structures and locations, for formats which may not be supported by the manufacturer.

Import manager 102 uses the system type and data location information to read data from collection point 12. Intelligent translator 104 uses the information within file format library 105 to translate this information into data which is compatible with the accounting system data format and file structure. Export manager 103 uses the file type and location information for the accounting system format to write the data either into the accounting system data files or to a data interchange file which can be directly read by the accounting system. Data is transferred intelligently in the sense that only the data that is needed is imported and the data is exported into the financial software data format for the particular financial software and in the sense that translator 104 will prevent transfers which violate basic accounting rules, as discussed later.

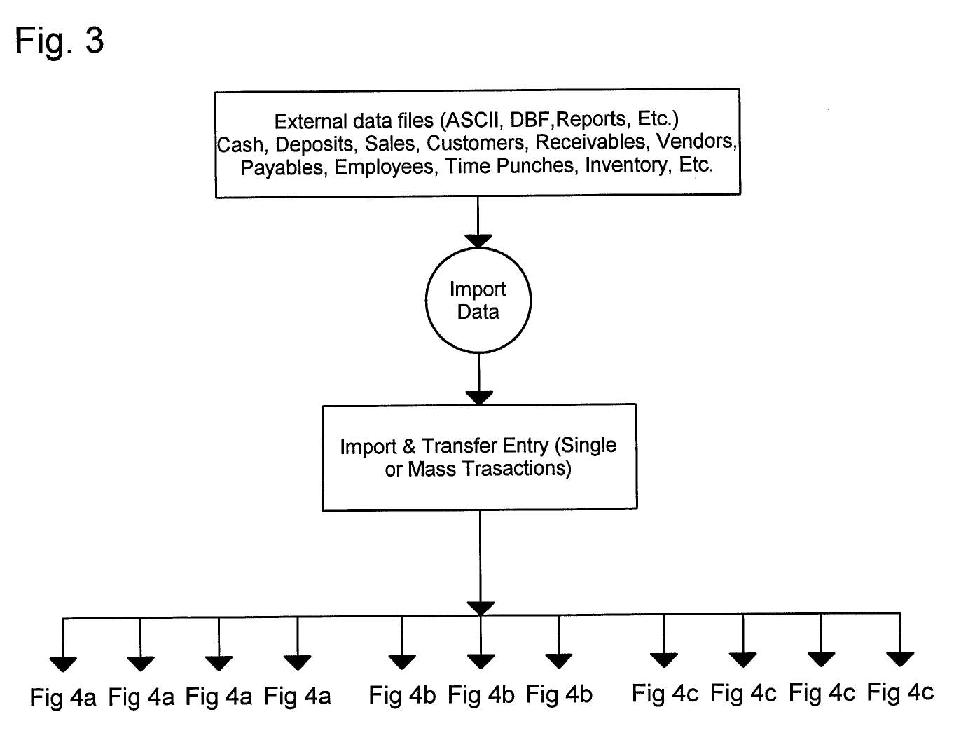

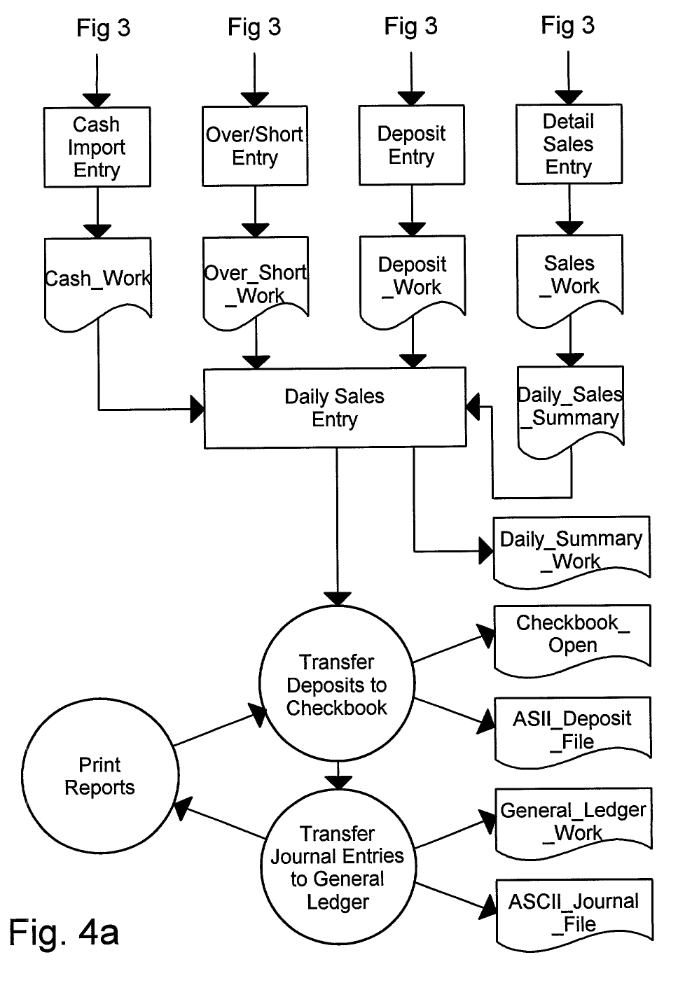

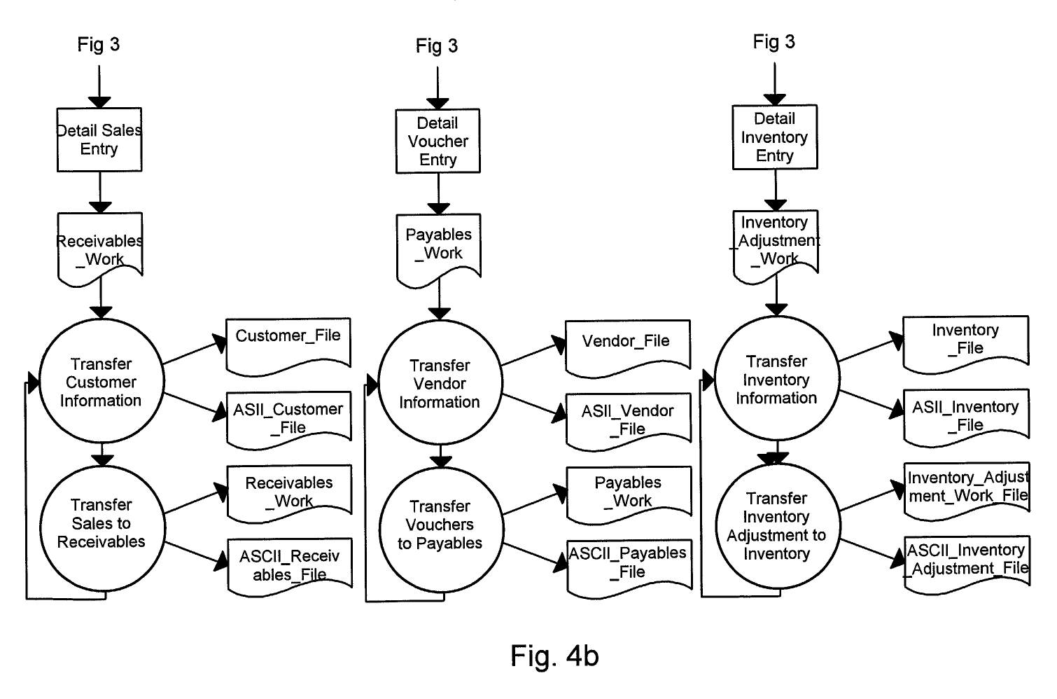

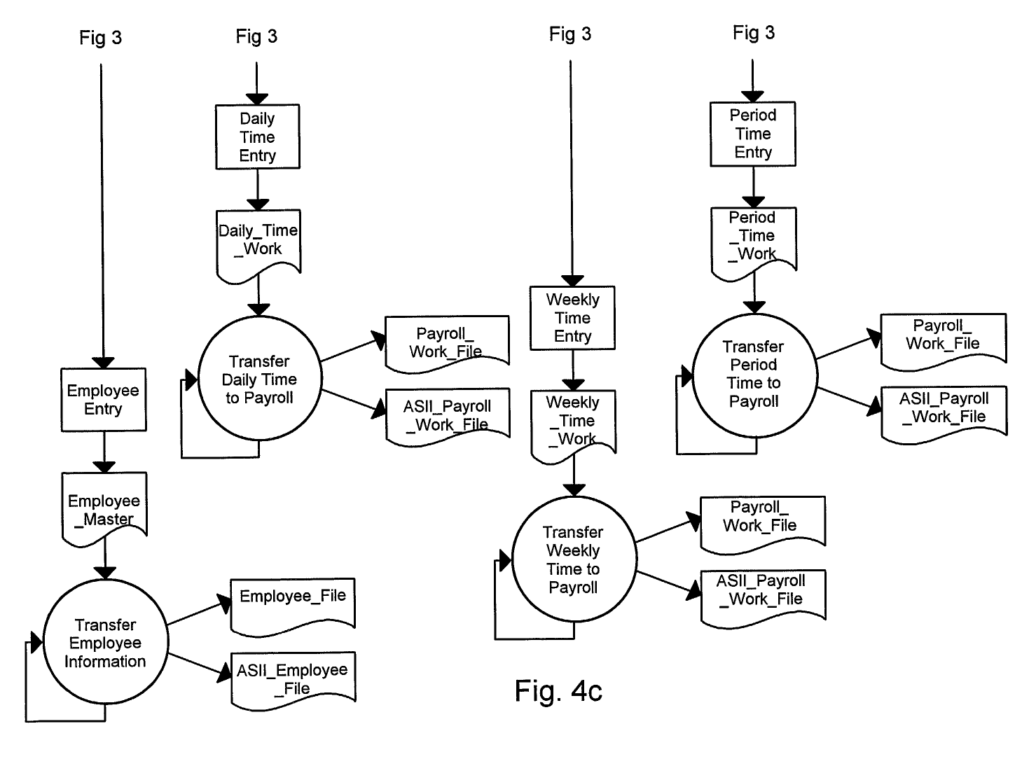

A procedural view of one embodiment of software 100 is shown in FIGS. 3, 4a, 4b and 4c. The cash, deposits, sales, customer, receivables, vendor, payables, employee, time entry, inventory and similar information may be stored in many various data formats such as ASCII formats, dBase (DBF) format, spreadsheet application formats, or a proprietary format unique to the data collection system. This information can be imported as single transaction entries or mass transactions as is shown in FIG. 3.

FIG. 4a illustrates the cash import, over/short, deposit and detail sales entry procedures. Import manager 102 uses the data location information stored during configuration as well as the information within file format library 105 to read the cash import, over/short deposit and detail sale entries either directly from data collection point 12 or from a duplicate file structure either on computer 10 or on some other accessible electronic storage device. This data is then stored within program work files designated as cash_work, over_short_work, deposit_work and sales_work, respectively.

FIG. 4b illustrates the detail sales, detail voucher, and detail inventory entry procedures. Similarly, import manager 102 reads the detail sale entries, detail voucher entries and detail inventory entries. This data is then stored within work files or memory locations designated as receivables_work, payables_work and inventory_adjustment_work.

FIG. 4c illustrates the employee, daily time, weekly time and period time entry procedures. Again, import manager 102 reads the employee entries, daily time entries, weekly time entries and period time entries. This data is then stored within program work files designated as employee_master, daily_time_work, weekly_time_work and period_time_work.

All, or the selected portions, of this data is then summarized and presented to the user through GUI 101 for verification. The user then instructs the software to transfer all or selected portions of the data. All of the daily sales entries, including cash import entries, over/short entries, deposit entries and detail sales entries are written to a daily_summary_work file. In the case where the data is transferred directly into the financial software's data files, the daily deposit(s) are transferred into the checkbook register(checkbook_open) and the journal entries, including the deposits, are transferred directly into the general ledger data files(general_ledger_work). Additionally, the customer information portions of the detail sales entries are transferred directly to the customer_file and the receivables portion of the detail sales entries are transferred into the receivables_work file of the financial software. The vendor information portions of the detail voucher entries are transferred directly into the vendor_file while the payables information of the detail voucher entries are transferred directly into the payables_work file of the financial software. The inventory information portions of the detail inventory entries are transferred directly into the inventory_file while the inventory adjustment portion of the detail inventory entries are transferred directly into the inventory_adjustment_work file. Import manager 102 reads the detail sale entries, detail voucher entries and detail inventory entries. This data is then stored within work files or memory locations designated as receivables_work, payables_work and inventory_adjustment_work_file of the financial software. Similarly, the employee entries are transferred directly into the employee_file while the daily time entries, weekly time entries and period time entries are transferred into the payroll_work_file of the financial software.

In the case where the data is formatted into an import file for the financial software, a data import file is written which includes the checkbook deposits, journal entries, customer information, detail sales information, vendor information, voucher information, inventory information, inventory adjustment information, employee information, daily time information, weekly time information and period time information in an import file format specific to the financial software.

There is almost never a one to one correspondence between the amount of data which is available for import and the final data which is exported to the financial software. Most data collection systems track much more data than what is normally imported to a financial package. For instance, each individual item within a single transaction is tracked along with the time of the transaction, the sales person, the payment method, credit card or check numbers, and virtually any other information which the owner has configured the data collection system to collect. Some of this information is simply not used by the financial software and other information requires translation or combination with other information prior to import into the financial software. The relationships between the collected data and the input data to the financial software are often not direct. One or more pieces of collected data may need to be input in several locations in the financial software data files and/or one or more of them may form a part of a composite piece of one or more pieces of financial software data.

As part of the accounting intelligence, the invention provides an interlock to warn or prevent duplicate transfers. This feature can be disabled if desired. Additionally, the user can select different file names for each import file created, in the case where import files are used. Intelligent translator 104 checks the integrity of the data, which includes checking the data content against the data type to make sure a numeric data type doesn't include date content for example and it checks the data content for validity by applying rules which may follow generally accepted accounting principles (GAAP). This later check prevents the transfer of data if the detail figures do not add up to the total figures, for example. Additional validation may include preventing negative employee hours information or other obviously erroneous data. However, as a general principle, the invention is not concerned with traditional reasonableness determinations characteristic of auditing and business analysis. Instead, it is primarily concerned with data integrity. This embodiment of the invention does maintain one or more audit logs which record transactions and user identification information to facilitate auditing. The invention maintains its own audit log and provides audit data to the financial software if that software supports that feature.

The general method of the invention involves the acts of gathering location information from a user as a result of queries requesting the location and file types of the files that contain specific types of financial data needed by the financial package; using and maintaining extensive import and export file format libraries which contain file structure information and data validation rules; and incorporating and applying extensive accounting intelligence to translate raw transaction data into meaningful financial data in the particular financial software data format.

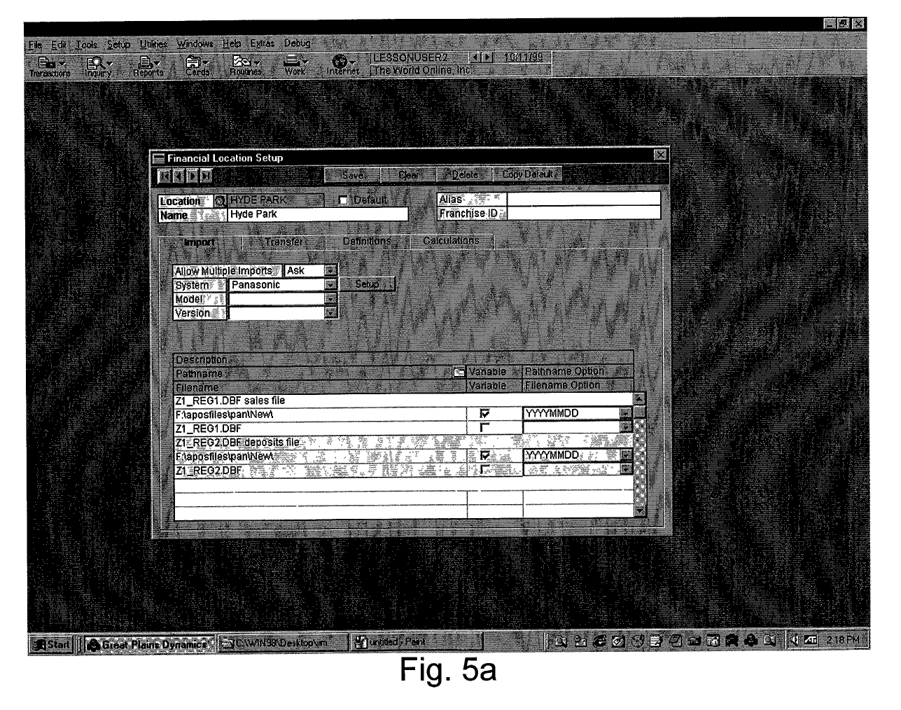

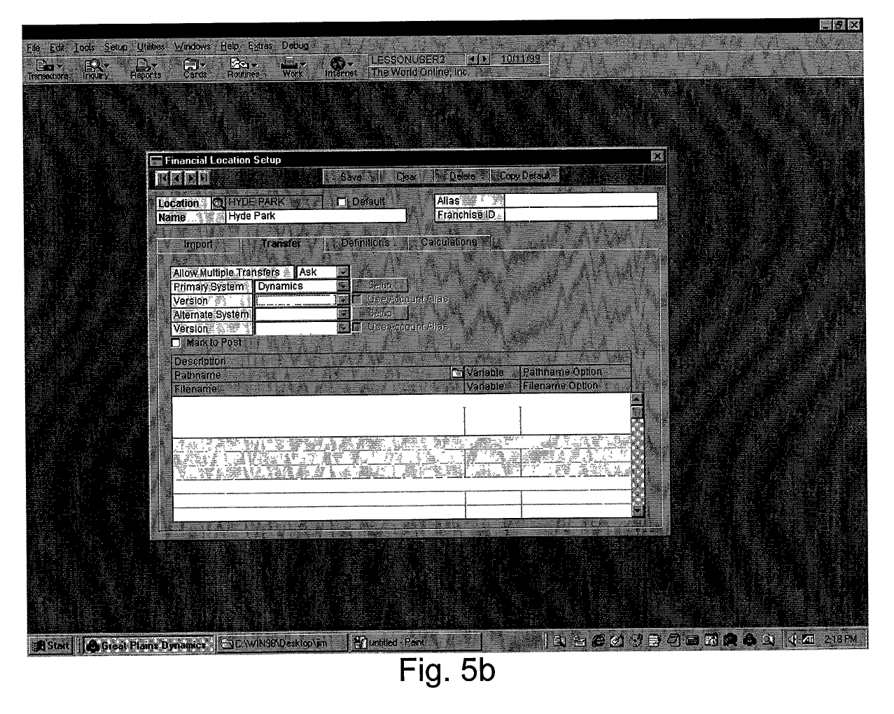

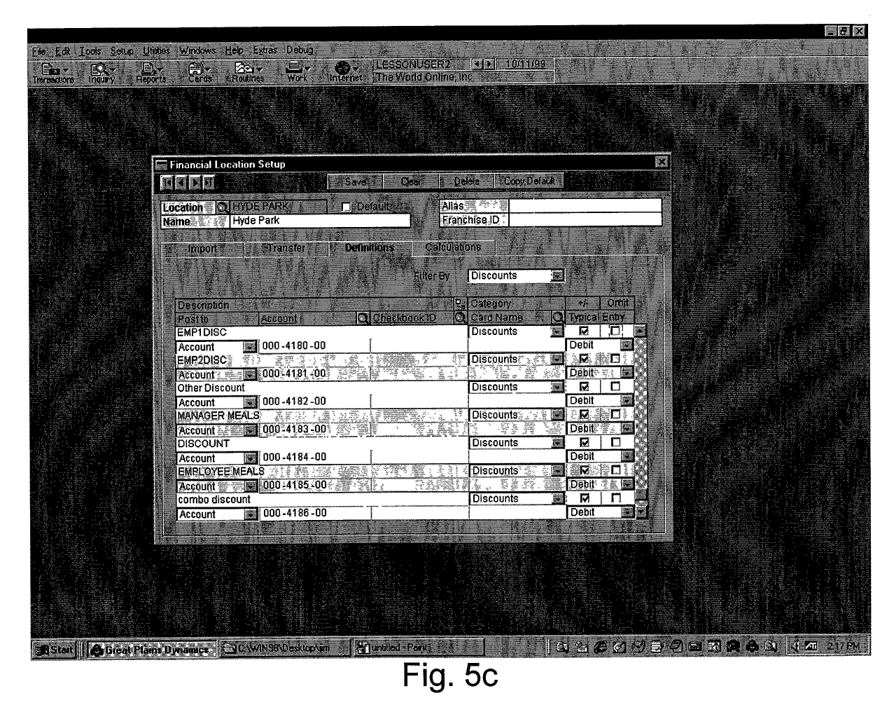

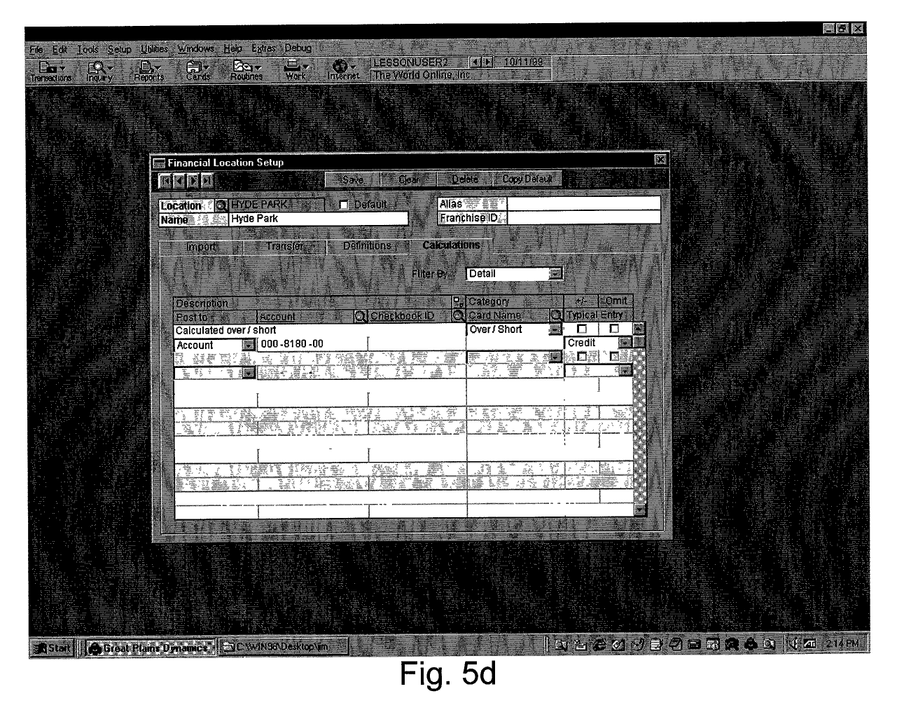

FIG. 5a shows one embodiment of a financial location import setup screen. Note the “Allow Multiple Imports” drop down selection box which has the value of “Ask”. Other possible choices include “No” and “Yes”. Similar choices and logic occur through the various menus. These choices allow for control of some of the stringency of the accounting intelligence by preventing, allowing or reaffirming potentially problematic transactions. As discussed earlier, this screen queries the user for the type of data collection system, data paths, etc. FIG. 5b shows one embodiment of a financial location transfer setup screen. This screen queries the user for financial software information to determine the particular financial software data format and data destination. FIG. 5c shows one embodiment of a financial location definition setup screen. This screen allows the user to setup accounts consistent with the financial software accounts and categories. FIG. 5d shows one embodiment of a financial location calculations setup screen. This screen allows the user to define any calculations which may be necessary to translate or verify data.

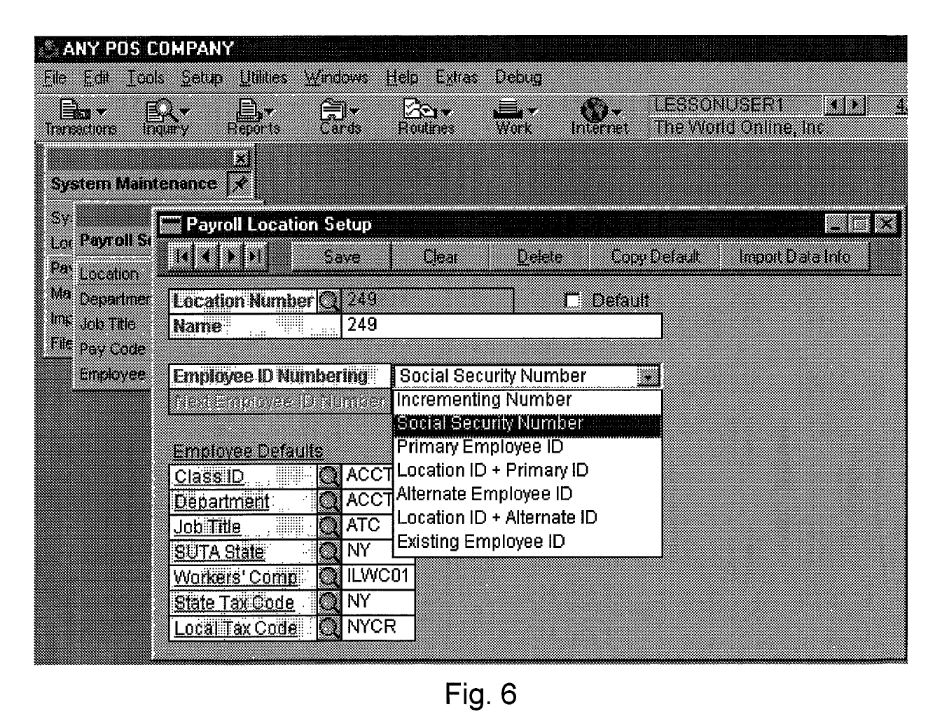

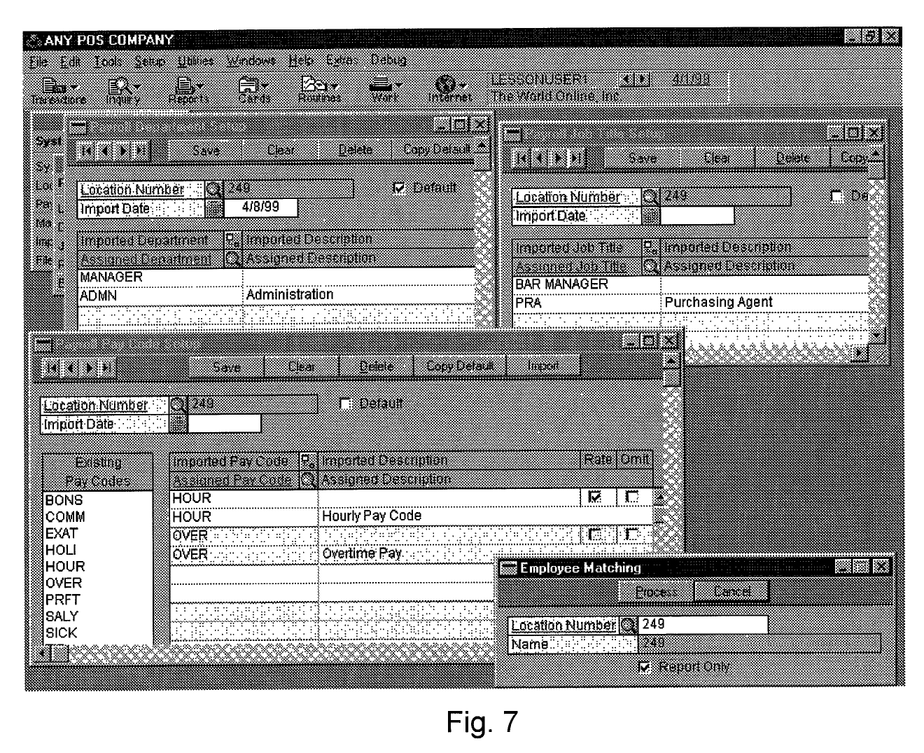

FIGS. 6 and 7 show one embodiment of payroll location setup screens. These screens allow the user to setup the payroll configuration including payroll departments, job titles, pay codes and employee matching.

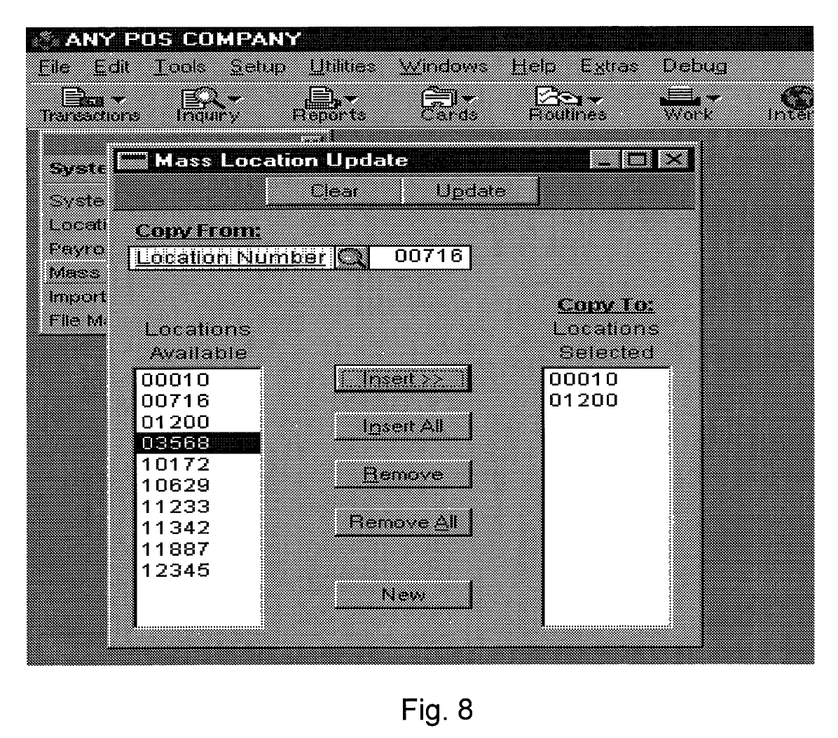

FIG. 8 shows one embodiment of a screen for a mass location updating. This screen allows setup information to be copied from one location, e.g. store, to one or more other locations. Hence, duplicative setup information only need be entered once and copied to other locations.

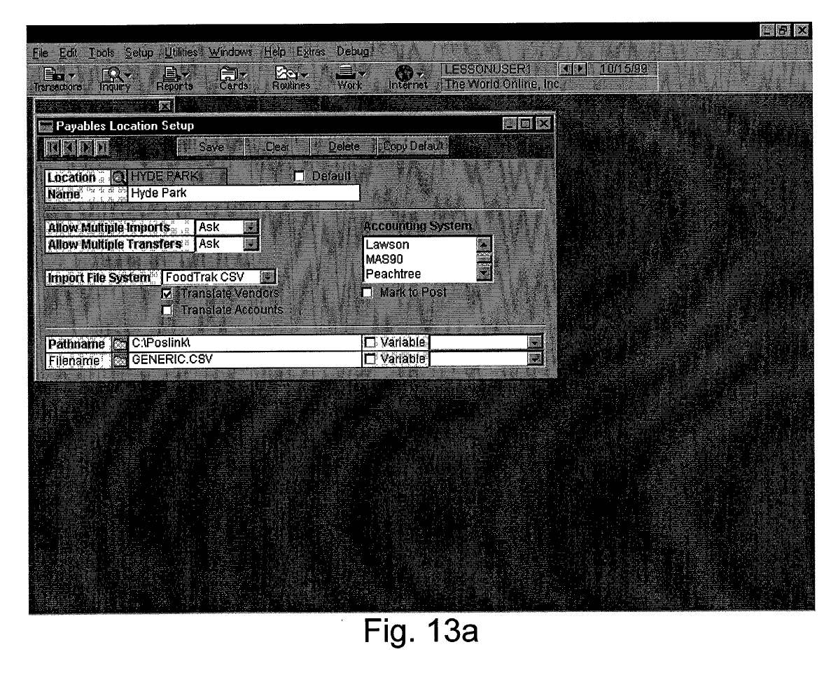

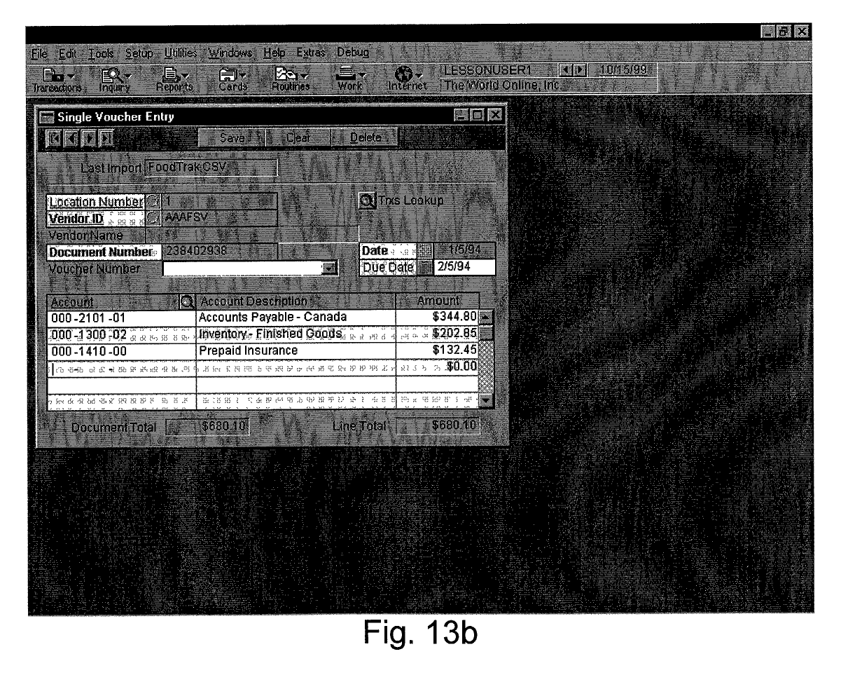

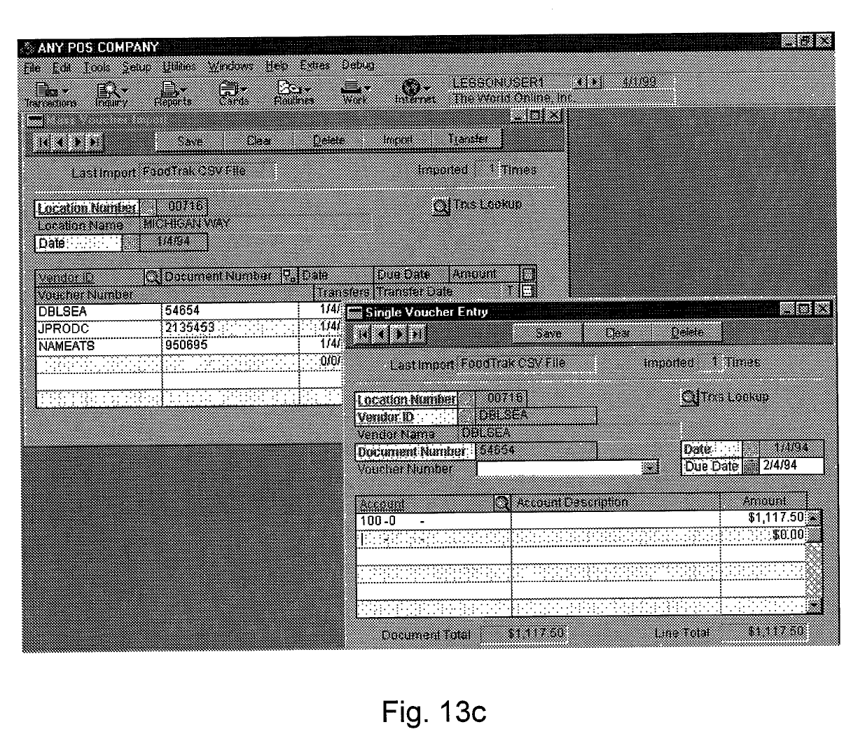

FIG. 13a shows one embodiment of a payables location setup screen. This screen allows the user to setup the payables configuration. The receivables configuration is virtually identical with the exception that the data is customer data as opposed to vendor data, e.g. invoices instead of vouchers.

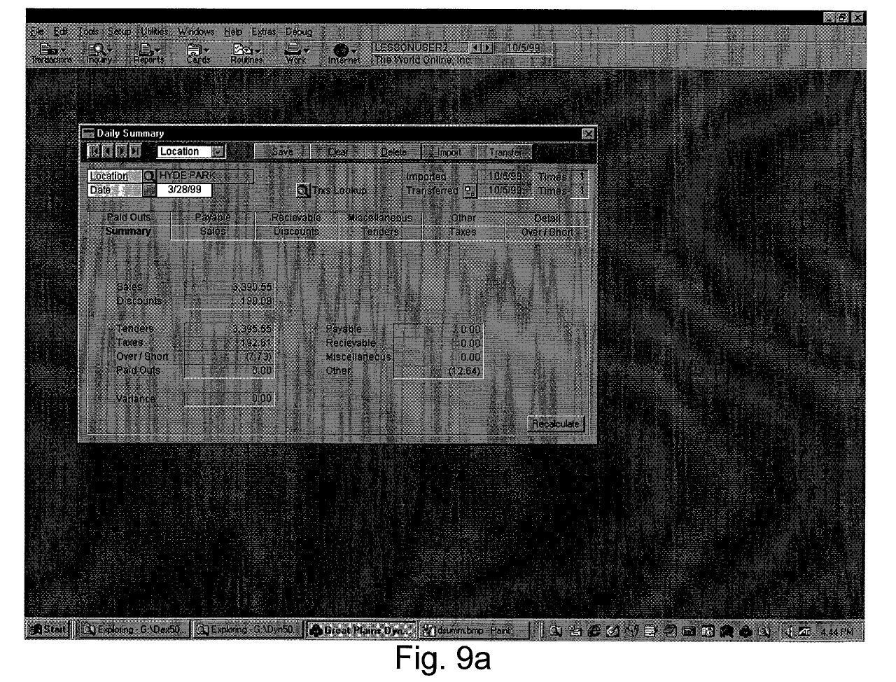

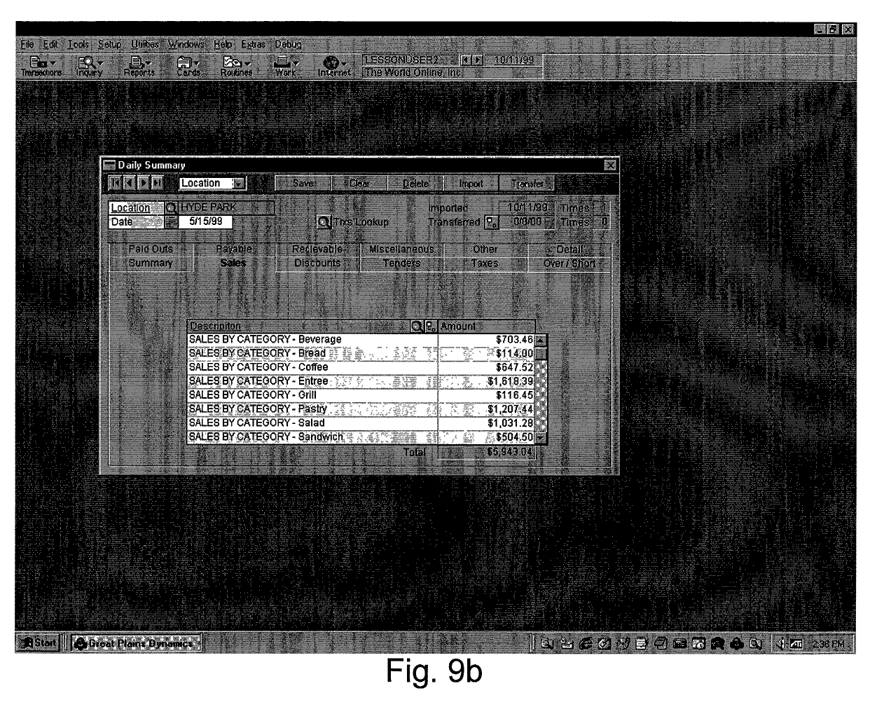

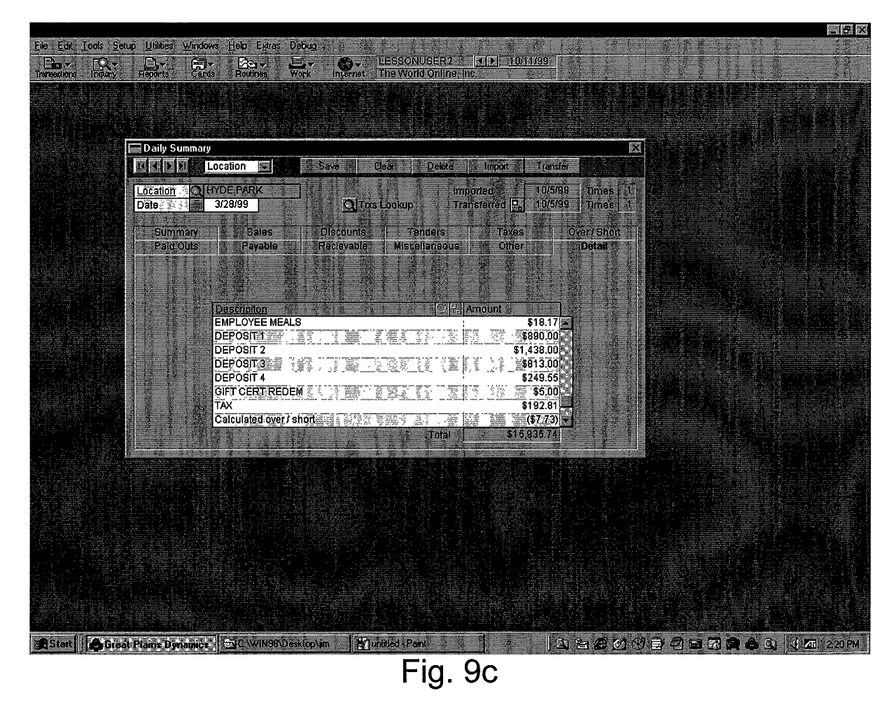

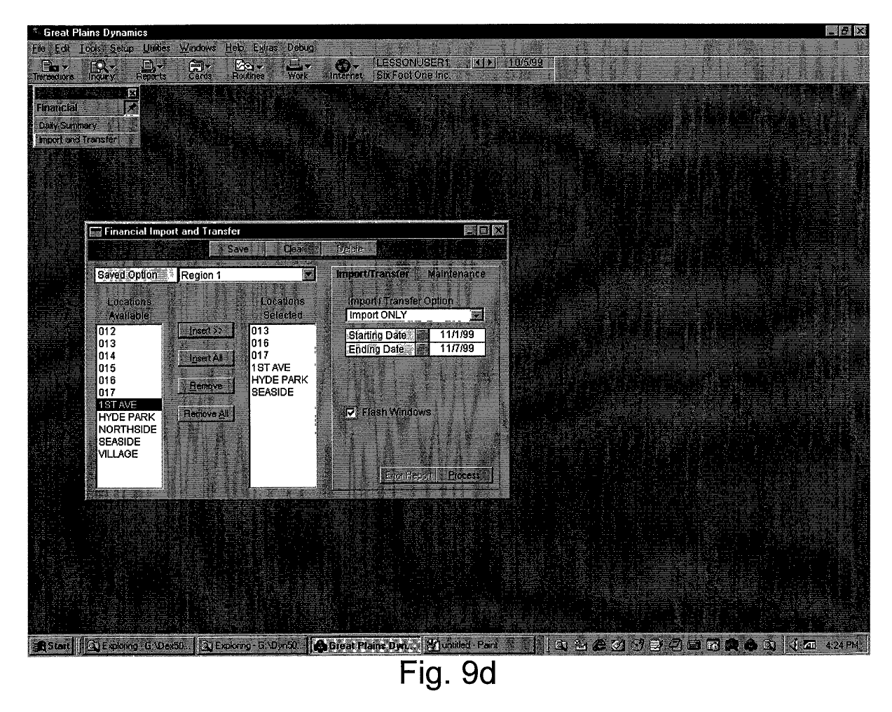

FIGS. 9a, 9b, 9c and 9d show one embodiment of daily summary screens. These are some of the screens the user interacts with during the import and transfer process to obtain immediate feedback and prior to actual transfer. These screens control the transfer process, provide detailed information about the data and allow to verify and validate the transfer.

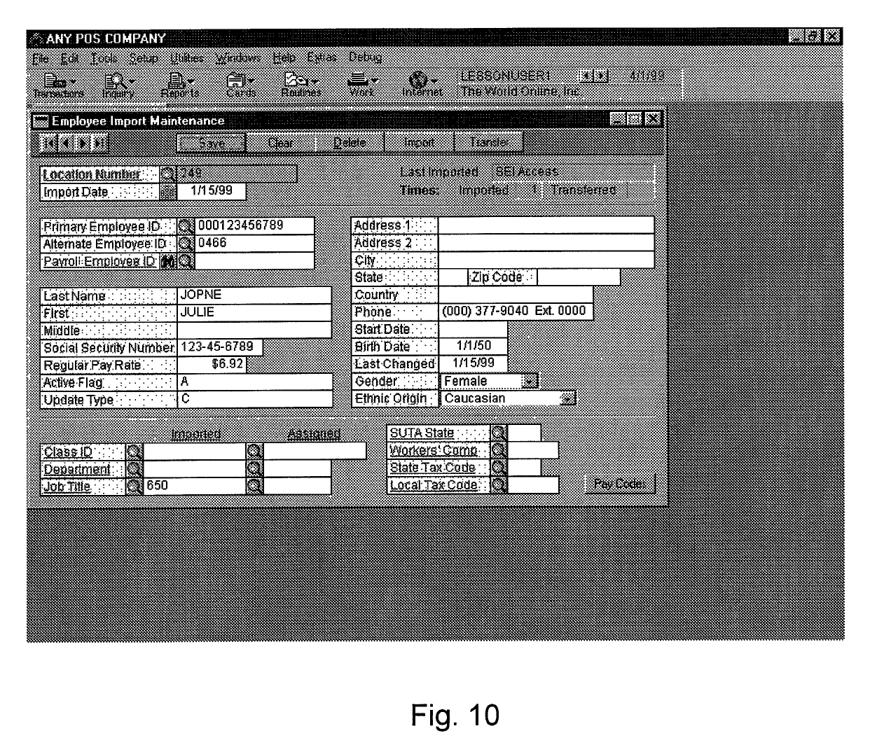

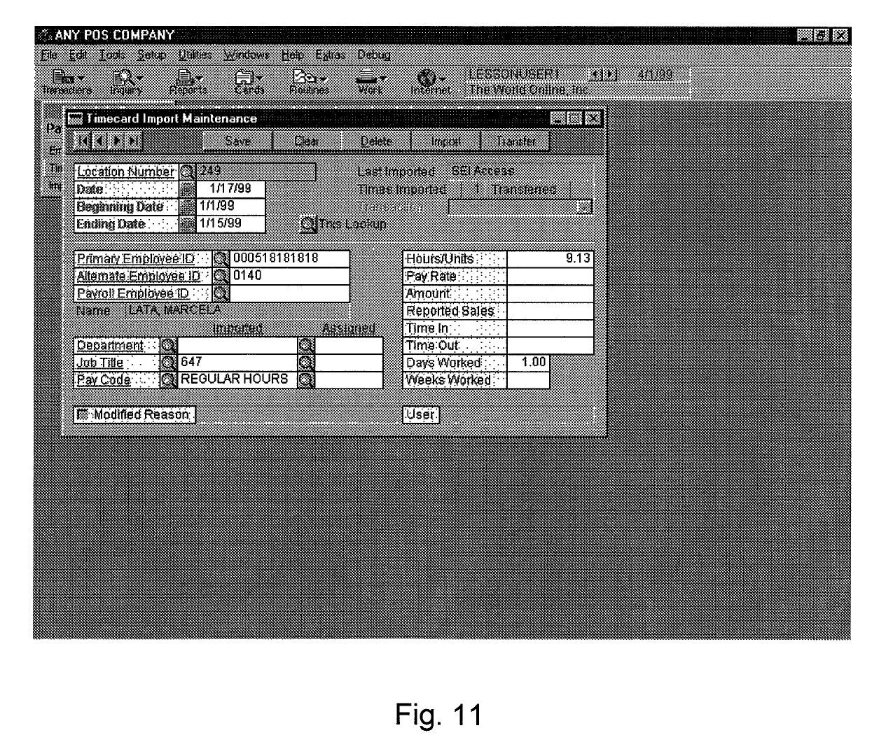

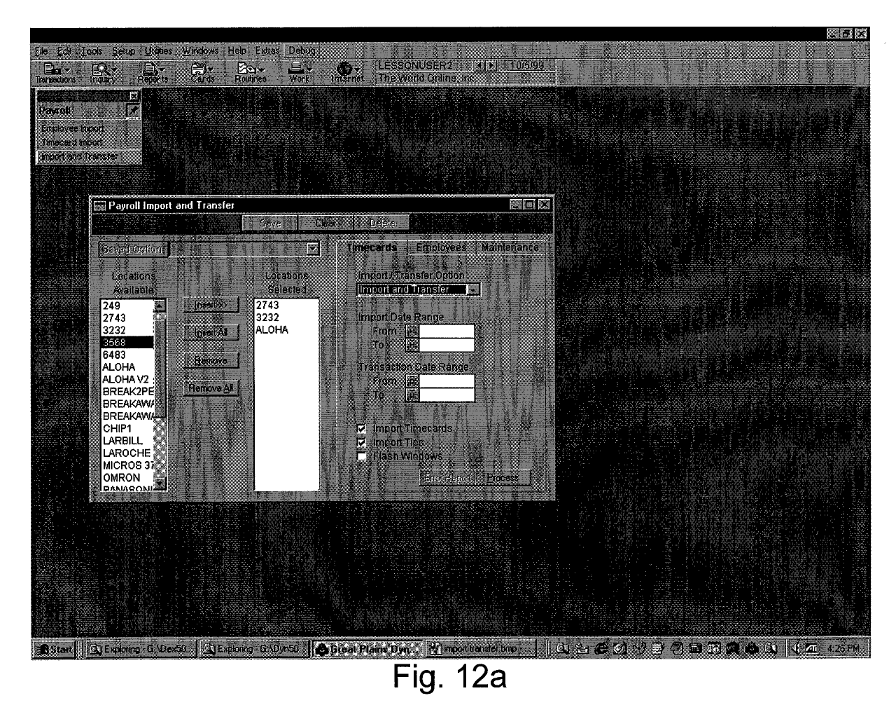

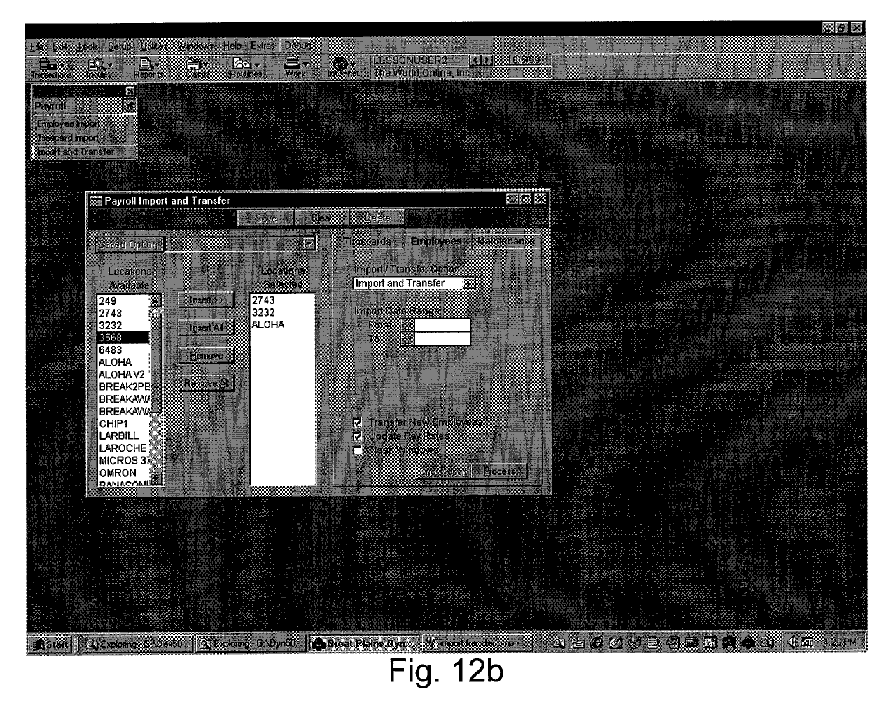

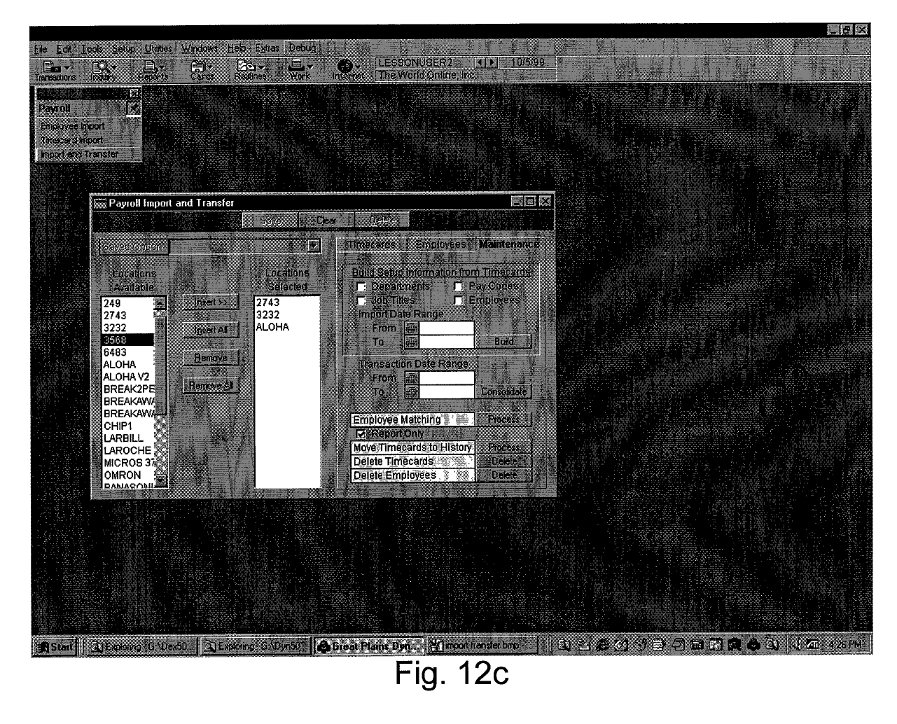

FIG. 10 shows one embodiment of an employee import maintenance screen which allows the user to enter and update employee information. FIG. 11 shows one embodiment of a timecard import maintenance screen which allows the user to import and transfer timecard information on an individual basis. FIG. 12a shows one embodiment of a timecard payroll import and transfer screen which allows timecard information import and transfer for one or more entire locations at a time. FIG. 12b shows one embodiment of employee information import and transfer screen which allows employee information import and transfer for one or more entire locations at a time. FIG. 12c shows one embodiment of a payroll maintenance information import and transfer screen which allows payroll maintenance information import and transfer for one or more entire locations at a time.

FIG. 13b shows one embodiment of a single voucher entry screen which allows import and transfer of single voucher entries. FIG. 13c shows one embodiment of a mass voucher import screen which allows voucher information import and transfer for one or more entire locations at a time. The receivables information import and transfer screens are here essentially identical payables voucher screen with the exception that they are invoices instead of vouchers.

While there are shown and described certain embodiments of the invention, it is to be distinctly understood that this invention is not limited thereto but may be variously embodied to practice within the scope of the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A software program for importing remote transaction tracking data into a financial software package within a computer containing instructions that when executed by the computer perform the following acts:
gathering information concerning file location and format of data to be imported as well as information concerning file location and format of the financial software package's data structure;
reading data to be imported;
checking the data for accounting rule violations and data type validity; and
writing the data into a financial software data format to be directly accessed by the financial software package.
